(19) United States
(12) Patent Application Publication
(10) Pub. No.: US 2018/0072052 A1
(43) Pub. Date: Mar. 15, 2018

(54) INK JET HEAD

(71) Applicant: TOSHIBA TEC KABUSHIKI KAISHA, Tokyo (JP)

(72) Inventor: Masato FUKASAWA, Izunokuni Shizuoka (JP)

(21) Appl. No.: 15/660,444

(22) Filed: Jul. 26, 2017

(30) Foreign Application Priority Data
Sep. 15, 2016 (JP) 2016-180589

(51) Int. Cl. B41J 2/045

(52) U.S. Cl. CPC B41J 2/04563; B41J 2/04581

(57) ABSTRACT

According to one embodiment, an ink jet head includes a first pressure chamber connected to a first nozzle, a first actuator substrate including a first actuator that is configured to cause a pressure change in the first pressure chamber to discharge ink through the first nozzle in response to a first driving signal, a first driving circuit configured to generate the first driving signal, a first temperature adjustment unit in contact with the first driving circuit and having a first thermal conductivity, and a second temperature adjustment unit having an internal flow path through which a liquid can flow and a second thermal conductivity that is lower than the first thermal conductivity, the second temperature adjustment unit being in contact with the first actuator substrate.

### CROSS-REFERENCE TO RELATED APPLICATION

This application is based upon and claims the benefit of priority from Japanese Patent Application No. 2016-180589, filed Sep. 15, 2016, the entire contents of which are incorporated herein by reference.

### FIELD

Embodiments described herein relate generally to a temperature adjustment mechanism of an ink jet head.

### BACKGROUND

An existing ink jet printer forms an image or a text character on a medium such as a paper sheet by causing an ink droplet to adhere to the medium. The inkjet printer includes an ink jet head which discharges ink droplets according to an input signal corresponding to the desired image or text.

The ink jet head includes a nozzle from which an ink droplet is discharged, an ink pressure chamber in fluid communication with the nozzle, and a pressure generating element which generates pressure for discharging ink from the pressure chamber via the nozzle. A piezoelectric material is used in forming the pressure generating element. A piezoelectric element, also referred to as a piezo element, operates when the piezoelectric material electromechanically converts a voltage into a force or a change in shape. A pressure is thus applied to the ink in the pressure chamber by the deformation or change in shape of the piezoelectric element. Due to the pressure applied to the ink, the ink is discharged from the nozzle. As a piezoelectric material, lead zirconate titanate (PZT) is commonly used.

When the ink is repeatedly discharged from the ink jet head by the piezoelectric element being driven, the piezoelectric element generates heat. Due to the heat generated by the piezoelectric element, the temperature of the ink in the pressure chamber may increase. As a result, the viscosity of the ink may decreases and the amount of discharged ink may change as a result. To suppress the change in the amount of discharged ink, it is necessary to control an increase in temperature of the ink jet head.

### BRIEF DESCRIPTION OF THE DRAWINGS

FIG. 1 is a schematic side view of an ink jet printer according to a first embodiment.

FIGS. 2A and 2B are a perspective view and a cross-sectional view of an inkjet head according to the first embodiment.

FIG. 3 is a perspective view of an ink jet head according to the first embodiment.

FIGS. 4A and 4B are views of a driving circuit of an ink jet head in the first embodiment.

FIG. 5 is a cross-sectional view of a temperature adjustment unit of the ink jet head in FIG. 2A.

FIG. 6 is a diagram illustrating temperature characteristics of an ink jet head according to the first embodiment.

FIG. 7 is a diagram illustrating temperature characteristics of an ink jet head according to the first embodiment.

FIG. 8 is a perspective view of an ink jet head according to a second embodiment.

FIG. 9 is a perspective of an ink jet head according to a third embodiment.

FIG. 10 is a cross-sectional view of an ink jet head according to a fourth embodiment.

FIG. 11 is a perspective view of a temperature adjustment unit of an ink jet head in a comparative example.

### DETAILED DESCRIPTION

According to an embodiment, an ink jet head includes a first pressure chamber connected to a first nozzle, a first actuator substrate including a first actuator that is configured to cause a pressure change in the first pressure chamber to discharge ink through the first nozzle in response to a first driving signal, a first driving circuit configured to generate the first driving signal, a first temperature adjustment unit in contact with the first driving circuit and having a first thermal conductivity, and a second temperature adjustment unit having an internal flow path through which a liquid can flow and a second thermal conductivity that is lower than the first thermal conductivity, the second temperature adjustment unit being in contact with the first actuator substrate.

Hereinafter, example embodiments will be described with reference to drawings. In the drawings, the same reference numerals are used to indicate the same components.

### First Embodiment

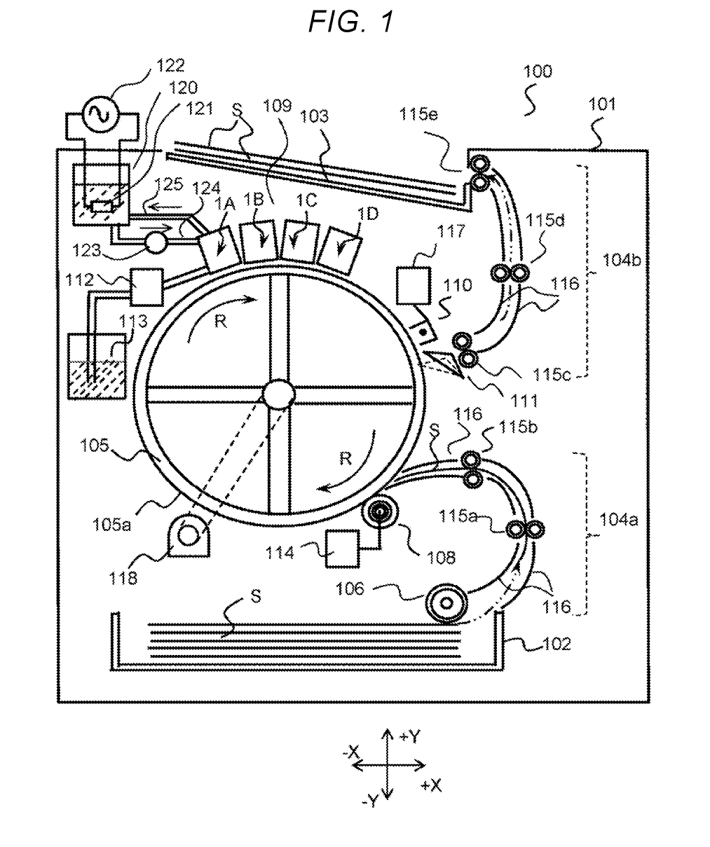

FIG. 1 illustrates a section of an ink jet printer 100 including ink jet heads (1A, 1B, 1C, and 1D) according to a first example embodiment. The ink jet heads 1A to 1D in a printing unit 109 respectively discharge cyan ink, magenta ink, yellow ink, and black ink so that an image can be recorded on a recording medium S, also referred to as a paper sheet, according to an image signal input from an external device connected to the ink jet printer 100.

In this example, the recording medium S is a plain paper sheet, an art paper sheet, a coated paper sheet, or the like.

The ink jet printer 100 includes a box-shaped housing 101. In the housing 101, a paper feeding cassette 102, an upstream side transporting path 104a, a holding drum 105, the printing unit 109, a downstream side transporting path 104b, and a discharging tray 103 are provided, which are arranged in this order in a direction from the lower portion to the upper portion in the Y axis direction. The paper feeding cassette 102 accommodates a paper sheet S onto which printing is performed by the ink jet printer 100. The printing unit 109 includes four inkjet heads, which are the inkjet head 1A for cyan ink, the ink jet head 1B for magenta ink, the ink jet head 1C for yellow ink, and the inkjet head 1D for black ink. The ink jet heads 1A to 1D are units which are used to record an image by discharging an ink droplet on the paper sheet S which is held on the holding drum 105.

The paper feeding cassette 102 accommodates the paper sheet S and is provided in the lower portion of the housing 101. A paper feeding roller 106 feeds the paper sheet S from the paper feeding cassette 102 to the upstream side transporting path 104a one by one. The upstream side transporting path 104a includes pairs of feeding rollers 115a and 115b and a paper sheet guiding plate 116, which restricts the transportation direction of the paper sheet S. The paper sheet S is transported when the pairs of feeding rollers 115a and 115b are rotated and is fed to the outer circumferential surface of the holding drum 105 while being guided by the paper sheet guiding plate 116 after passing through the pair of feeding rollers 115b. A dashed arrow in FIG. 1 indicates a route in which the paper sheet S is guided.

The holding drum 105 is an aluminum cylinder which includes a thin resin-made insulating layer 105a on a surface thereon. The circumference of the cylinder is greater than the longitudinal length of the paper sheet S onto which an image is recorded, and the axial length of the cylinder is greater than the lateral length of the paper sheet S. The holding drum 105 is rotated by a motor 118 at a constant circumferential speed in a direction along the arrow R. The insulating layer 105a of the holding drum 105 rotates with the paper sheet S being held thereon due to static electricity so that paper sheet S is transported to the printing unit 109. A charging roller 108 which charges the insulating layer 105a with static electricity is disposed along the insulating layer 105a.

The charging roller 108 includes a metal rotation shaft and includes a conductive rubber layer around the rotation shaft. The charging roller 108 is connected to a high voltage generating circuit 114. A surface of the conductive rubber layer is in contact with the insulating layer 105a of the holding drum 105, and the charging roller 108 is driven by a motor such that the charging roller 108 is rotated at the same circumferential speed as the circumferential speed of the holding drum 105. The insulating layer 105a of the holding drum 105 and the conductive rubber layer of the charging roller 108 are in contact with each other so that a sheet nip is formed therebetween. The paper sheet S is fed to the nip by the pair of feeding rollers 115b and the paper sheet guiding plate 116. A high voltage which is generated by the high voltage generating circuit 114 is applied to the metal shaft of the charging roller 108 immediately before the paper sheet S is transported to the nip. The insulating layer 105a is charged with the high voltage and the paper sheet S, which has been transported to the nip, is also charged so that the paper sheet S is electrostatically attracted onto the outer circumferential surface of the holding drum 105. The electrostatically attracted paper sheet S is fed to the printing unit 109 by the holding drum 105 being rotated.

The printing unit 109 is fixed to the ink jet printer 100 with ink discharging surfaces of the ink jet heads 1A to 1D being separated from the outer circumferential surface of the holding drum 105 by 1 mm. Each of the ink jet heads 1A to 1D is longer in the axial direction of the holding drum 105, along a main scanning direction, and shorter in a rotation direction, along a sub scanning direction. The inkjet heads 1A to 1D are arranged at intervals in the circumferential direction of the holding drum 105. Details of configurations of the inkjet heads 1A to 1D will be described later. An ink tank 113 is an ink container which stores cyan ink. An ink supply device 112 is disposed between the ink tank 113 and the ink jet head 1A. The ink supply device 112 includes a pump and a pressure adjustment mechanism. The cyan ink in the ink tank 113, which is disposed at a lower position than the ink jet head 1A in the gravity direction, is supplied to the ink jet head 1A with the pump. The ink jet head 1A discharges an ink droplet in the gravity direction (−Y direction). It is necessary to maintain the pressure of the ink jet head 1A to be negative with respect the atmospheric pressure to prevent cyan ink from leaking from the ink jet head 1A during a stand-by state. The pressure adjustment mechanism adjusts the pressure of the ink to be negative with respect to the atmospheric pressure so that the ink supplied to the ink jet head 1A does not leak from a nozzle of the ink jet head 1A. Each of the ink jet heads 1B to 1D includes a similar ink tank 113 and a similar ink supply device 112, which are omitted in the drawings for simplicity of depiction.

A warm water tank 120 is provided to control the temperature of the ink jet head 1A. The warm water tank 120 includes water for controlling the temperature of the ink jet head 1A and a heater 121 that heats the water. A temperature controller 122 controls the heater 121 to be at a predetermined temperature. The pump 123 feeds the water heated by the heater 121 to the ink jet head 1A. The warm water, which is fed by the pump 123, is fed from the warm water tank 120 to the ink jet head 1A through a flow path 124. The warm water passes through a temperature adjustment unit of the ink jet head 1A and returns to the warm water tank 120 through a flow path 125. The warm water circulates between the warm water tank 120 and the temperature adjustment unit of the ink jet head 1A. The temperature adjustment unit will be described later. Warm water also circulates in the ink jet heads 1B to 1D in the same manner as in the ink jet head 1A. Warm water circulating devices of the ink jet heads 1B to 1D are not specifically depicted in the drawings.

In the printing unit 109, each of the ink jet heads 1A to 1D records an image by discharging ink onto the paper sheet S. The recorded image is drawn according to an image signal input from an external device associated with the ink jet printer 100. The inkjet head 1A discharges cyan ink to form a cyan image. Similarly, the inkjet head 1B discharges magenta ink, the ink jet head 1C discharges yellow ink, and the ink jet head 1D discharges black ink to record images in these respective colors. The ink jet heads 1A to 1D have the same configuration excepting for the color of ink discharged therefrom.

The paper sheet S on which recording has been finished in the printing unit 109 is transported to a neutralization device 110 and a separation claw 111. The neutralization device 110 is comprises a tungsten wire in a stainless steel housing that has a U-shaped section and has the same length as the axial length of the holding drum 105. The neutralization device 110 is disposed such that an opening of the U-shaped housing faces the outer circumferential surface of the holding drum 105. The high voltage generating circuit 117 generates a high voltage which has a reverse polarity as compared to the polarity of the voltage applied to the charging roller 108. When the tip end (e.g., front end of the sheet) of the paper sheet S on which recording has been finished is transported to a position below the neutralization device 110, the high voltage generated by the high voltage generating circuit 117 is applied between the housing and the tungsten wire. Due to the high voltage, a corona discharge occurs on the opening side of the neutralization device 110 so that the charged paper sheet S is electrically neutralized. The separation claw 111 is provided so as to be movable between a position at which the tip end of the separation claw 111 comes into contact with the outer circumferential surface of the holding drum 105 and a position at which the tip end is separated from the outer circumferential surface. Usually, the separation claw 111 is held at the position at which the tip end is separated from the outer circumferential surface. In a case of separating the paper sheet S from the holding drum 105, the tip end of the separation claw 111 comes into the outer circumferential surface of the holding drum 105 so that the tip end of the electrically neutralized paper sheet S is separated from the insulating layer 105a. After the tip end of the paper sheet S is separated from the outer circumferential surface, the separation claw 111 returns to the position at which the tip end of another sheet can be separated from the outer circumferential surface.

The paper sheet S, which is separated from the holding drum 105, is then fed to a pair of feeding rollers 115c. The downstream side transporting path 104b is constituted by pairs of feeding rollers 115c, 115d, and 115e and the paper sheet guiding plate 116, which restricts the transportation direction of the paper sheet S. The paper sheet S is discharged into the discharging tray 103 by being fed by the pairs of feeding rollers 115c, 115d, and 115e along a dashed arrow in FIG. 1.

A configuration of the ink jet head 1A will be described in detail. As described above, the ink jet heads 1B to 1D have the same configuration as the ink jet head 1A.

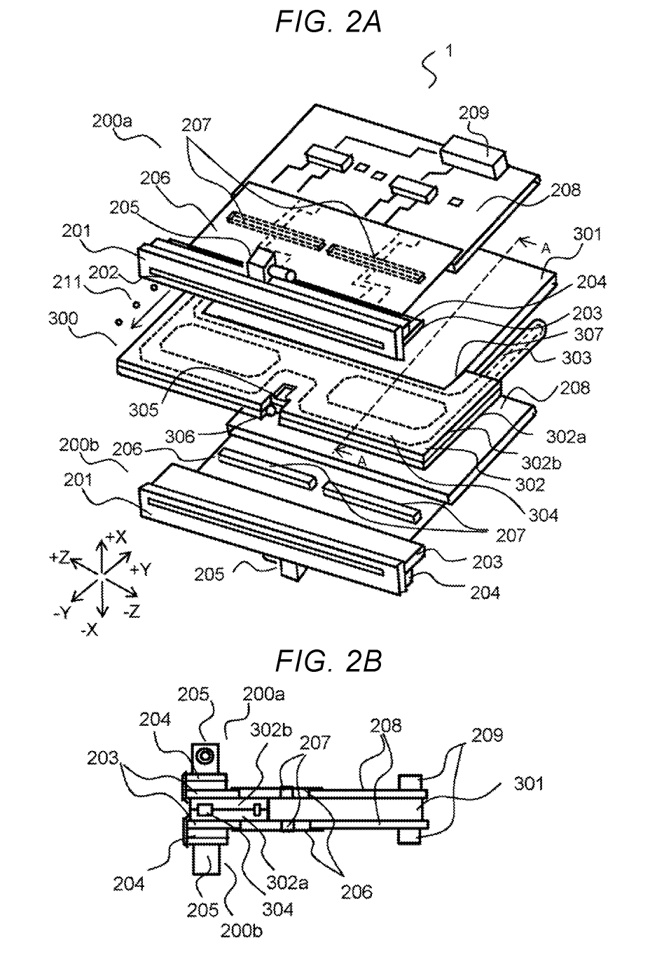

FIG. 2A is an external perspective view of an ink jet head 1. As illustrated in FIG. 2A, the ink jet head 1 includes ink discharging units 200a and 200b that discharge ink and a temperature adjustment unit 300 that adjusts the temperatures of the ink discharging units 200a and 200b. In the ink jet head 1 according to the first embodiment, the ink discharging units 200a and 200b are provided above and below the temperature adjustment unit 300, respectively, in the X axis direction. The upper and lower ink discharging units 200a and 200b have the same configuration as each other. The temperature adjustment unit 300 and the ink discharging units 200a and 200b are integrated with each other while being fixed to each other at a predetermined position with an epoxy adhesive agent. FIG. 2B illustrates a section of the integrated ink jet head 1 which is taken along line A-A.

A configuration of the ink discharging unit 200a will be described. The ink discharging unit 200a includes a mask plate 201, a nozzle plate 202, an actuator substrate 203, a top plate 204, and an ink supply port 205. Furthermore, the ink discharging unit 200a includes a flexible substrate 206 from which an electric signal is transmitted to the actuator substrate 203, driving circuits 207 which are mounted on the flexible substrate 206 and generate the electric signal, and a circuit substrate 208 which is connected to the flexible substrate 206. The flexible substrate is referred to as a flexible printed circuit (FPC).

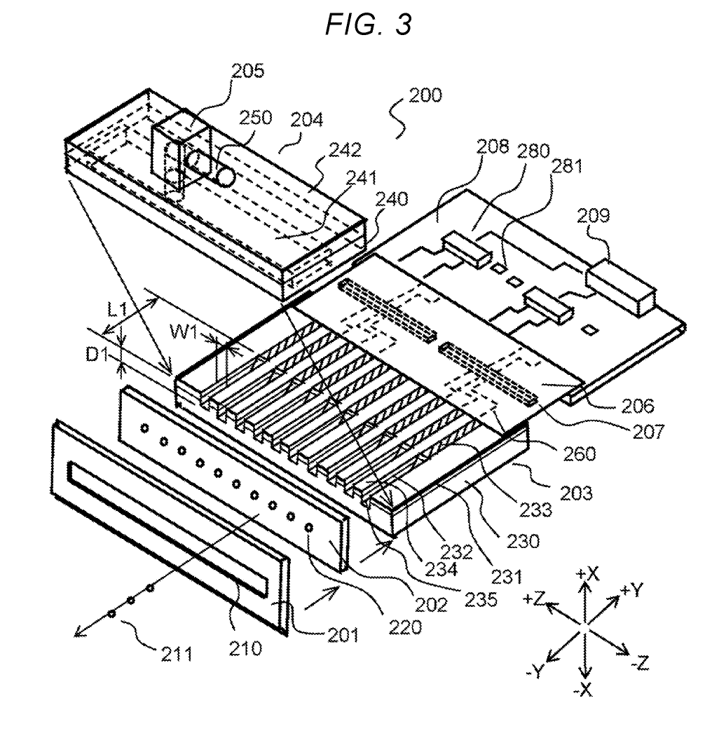

A configuration of the ink discharging unit 200a will be described with reference to FIG. 3. The mask plate 201 and the nozzle plate 202 are fixed to the actuator substrate 203 in a direction along the arrows. The mask plate 201 is a stainless steel plate which has a length of 60 mm in the Z axis direction, a length of 6 mm in the X axis direction, and a thickness of 0.1 mm. A rectangular opening 210, which has a length of 52 mm in the Z axis direction and has a length of 1.5 mm in the X axis direction, is formed in the center portion of the plate. The mask plate 201 is fixed to the nozzle plate 202 with the epoxy adhesive agent as illustrated by the arrow. In the nozzle plate 202, six hundred and ten nozzles 220, via which ink droplets 211 are discharged, are formed. The nozzle plate 202 has a length of 59 mm in the Z axis direction, has a length of 5 mm in the X axis direction, and a thickness of 30 μm and is formed of polyimide resin. The diameter of each nozzle 220 is 20 μm. The nozzles 220 are disposed in the center of the opening 210 in the X axis direction and are disposed while forming a straight line extending in the Z axis direction. A distance between adjacent nozzles in the Z axis direction is 0.085 mm. In FIG. 3, the number of nozzles is set to ten for an explanation of the ink discharging unit 200a, but the number is not limited ten and the number may be fewer or more than ten.

The nozzle plate 202 is fixed to an end portion of the actuator substrate 203 with the epoxy adhesive agent. The actuator substrate 203 is a stack of a first piezoelectric material 230 and a second piezoelectric material 231. The first and second piezoelectric materials 230 and 231 are formed of lead zirconate titanate (PZT). The first piezoelectric material 230 has a thickness of 1.4 mm in the X axis direction, a length of 12 mm in the Y axis direction, and a length of 60 mm in the Z axis direction. The first piezoelectric material 230 is polarized in the +X axis direction. The second piezoelectric material 231 has a thickness of 0.1 mm in the X axis direction, a length of 12 mm in the Y axis direction, and a length of 60 mm in the Z axis direction. The second piezoelectric material 231 is polarized in the −X axis direction. The first piezoelectric material 230 and the second piezoelectric material 231 forms a stacked piezoelectric component while being polarized in opposite directions.

In such a piezoelectric component, grooves 232 each of which has a depth D1, a length L1 in the Y axis direction, and a width W1 in the Z axis direction are formed from the second piezoelectric material 231 side. The depth D1 is 0.2 mm, the length L1 is 8 mm, and the width W1 is 0.044 mm. An interval between adjacent grooves 232 is 0.085 mm. In the first embodiment, six hundred grooves 232 are formed. A nickel (Ni) electrode film is formed on an inner surface of each groove 232. An extraction electrode 233, which is electrically connected to the Ni electrode in each groove, is formed on an upper surface of the second piezoelectric material. The extraction electrodes 233 are formed of Ni. The electrode and the extraction electrode 233 in each groove are formed using a Ni electroless plating method. The stacked piezoelectric component is interposed between electrodes in the two adjacent grooves. When a driving voltage, also referred to as an electric signal, is applied to the electrodes in the two adjacent grooves 232, a voltage orthogonal to the polarization direction is applied to the stacked piezoelectric component. A stacked piezoelectric component 234 is subject to shearing deformation due to a driving voltage. Due to the shearing deformation, the first piezoelectric material 230 and the second piezoelectric material 231 are deformed so that the volume of each groove is increased or decreased. The stacked piezoelectric component, which is subject to shearing deformation, is a piezoelectric actuator 234.

The top plate 204 is fixed to the upper surface of the second piezoelectric material 231 with the epoxy adhesive agent. Each of areas surrounded by the top plate 204 and the grooves 232 is a pressure chamber 235 which applies a discharge pressure to ink. The pressure chambers 235 are fixed to communicate with the nozzles 220 formed in the nozzle plate 202. The layered piezoelectric material in which the pressure chambers 235 are formed is referred to as a substrate.

The top plate 204 includes a first top plate 240, a second top plate 242, and the ink supply port 205. The first top plate 240 has a thickness of 1.5 mm in the X axis direction, a length of 8 mm in the Y axis direction, and a length of 60 mm in the Z axis direction. An opening 241 which has a length of 5 mm in the Y axis direction and a length of 56 mm in the Z axis direction is formed in the first top plate 240 at a position separated from an end portion in the Y axis direction by 1.5 mm. The first top plate 240 is formed of PZT. The PZT of the first top plate 240 is material having the same thermal expansion coefficient as the thermal expansion coefficient of the stacked piezoelectric component 234. The second top plate 242 is fixed to the first top plate 240 with the epoxy adhesive agent. The second top plate 242 has a thickness of 1.5 mm in the X axis direction, a length of 8 mm in the Y axis direction, and a length of 60 mm in the Z axis direction. The second top plate 242 is formed of the same material as the first top plate 240. The ink supply port 205 includes a cylindrical tube 250 which bends at a right angle in the ink supply port 205. The ink supply port 205 is fixed to the second top plate 242 such that the cylindrical tube 250 communicates with the opening 241 while passing ink through the second top plate 242. Ink is supplied to the opening 241 through the cylindrical tube 250. The opening 241 becomes a common ink chamber 241 from which ink is supplied to each groove 232 and each pressure chamber 235.

The number of extraction electrodes 233 which are provided being respectively correlated with the grooves 232 and are formed on the upper surface of the second piezoelectric material 231 is six hundred corresponding to the six hundred grooves. Electrode patterns 260 formed on the flexible substrate 206 are provided being correlated with the extraction electrode 233 formed in each groove 232. The electrode patterns 260 and the extraction electrodes 233 are electrically connected to each other by an anisotropic contact film (ACF) 236.

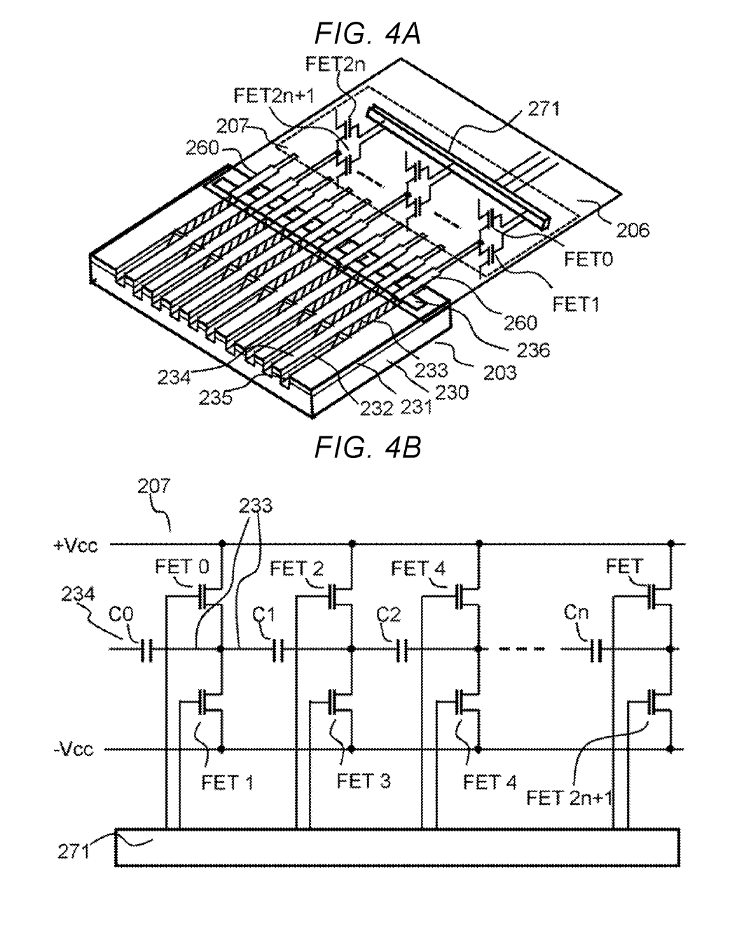

FIG. 4A illustrates the actuator substrate 203 and the flexible substrate 206. The extraction electrodes 233 which extend from the respective pressure chambers 235 are formed on the second piezoelectric material 231. The extraction electrodes 233 are electrically connected to the electrode patterns 260 of the flexible substrate 206 through the ACF 236. The electrode patterns 260 are respectively connected to field effect transistors (FET) of the driving circuit 207. Two FETs are disposed in series with a drain and a source being connected to each other. Each of the electrode patterns is connected to a portion in which the drain and the source are connected to each other. FIG. 4B illustrates an equivalent circuit of the electrode patterns 260 and the driving circuit 207. The driving FETs are connected to source voltages (+Vcc and −Vcc). Each piezoelectric actuator 234 has a configuration in which PZT material, which is a dielectric substance, is interposed between two electrodes. Therefore, each piezoelectric actuator 234 is indicated in the figure by the electrostatic capacitance (C0, C1, C2 . . . and Cn) thereof. In an example described below, the piezoelectric actuator 234 (e.g., C1) is driven. One particular extraction electrode 233, which is formed in one groove, serves as a common electrode of two adjacent piezoelectric actuators 234 (e.g., C0 and C1). The one particular extraction electrode 233 is connected to a FET 0 and a FET 1 of the driving circuit 207. An adjacent extraction electrode 233, which is connected to the piezoelectric actuators 234 (e.g., C1 and C2), is connected to a FET 2 and a FET 3. When the FET 0 and the FET 3 are turned on and the FET 2 and the FET 1 are turned off, the piezoelectric actuator 234 (represented by C1) is subject to shearing deformation so that a pressure is applied to ink in a pressure chamber 235. When the FET 2 and the FET 1 are turned on and the FET 0 and the FET 1 are turned off, the piezoelectric actuator 234 (represented by C1) is subject to shearing deformation in the opposite direction so that a pressure is applied to ink in an adjacent pressure chamber 235. A selection circuit 271 operates the FETs 0, 1 . . . 2n, and 2n+1 at a predetermined time. The driving circuit 207, which includes the selection circuit 271 and the plurality of FETs, is an integrated circuit (IC). When two adjacent piezoelectric actuators 234 are operated at the same time, the inner volume of the pressure chamber 235 increases or decreases. With a change in the inner volume of the pressure chambers 235, the ink droplets 211 are discharged via the nozzles 220. To discharge ink droplets from one pressure chamber 235, six FETs are operated.

The driving circuit 207 is mounted on a surface of the flexible substrate 206 on which the electrode patterns 260 are formed. The flexible substrate 206 has a length of 53 mm in the Z axis direction, a length of 20 mm in the Y axis direction, and a length of 0.05 mm in the X axis direction. Two driving circuits 207 are arranged in the Z axis direction on the center of the flexible substrate 206 in the Y axis direction. One driving circuit 207 supplies driving signals to three hundred extraction electrodes 233. Six hundred extraction electrodes 233 are arranged in the Z axis direction while being linearly formed in the Y axis direction. Six hundred electrode patterns 260 are also arranged in the Z axis direction while being linearly formed in the Y axis direction corresponding to the extraction electrodes 233. The electrode patterns 260, which are arranged in the Z axis direction, are connected to the driving circuits 207. Therefore, each of the driving circuits 207 has a length of 20 mm in the Z axis direction, a width of 2 mm in the Y axis direction, and a height of 1.5 mm in the X axis direction and has a rectangular shape. The extraction electrodes 233 are connected to the electrode patterns 260, which are arranged in the Y axis direction, via the ACF and the electrode patterns 260 are connected to the driving circuits 207. Furthermore, the flexible substrate 206 is connected to the circuit substrate 208 via the ACF. The circuit substrate 208 includes a signal generating circuit 280 which operates the selection circuit 271 according to printing data input from an external device, the source voltages (+Vcc and −Vcc) of the FETs, and a temperature detection circuit 281. In addition, a connector 209 for receiving a signal input from an external device is mounted on the circuit substrate 208.

As illustrated in FIG. 2A, the temperature adjustment unit 300 includes a first temperature adjustment unit 301 and a second temperature adjustment unit 302. In an example, the first temperature adjustment unit 301 comprises an aluminum (Al plate which has a length of 51 mm in the Y axis direction and a length of 32 mm in the Z axis direction. The aluminum plate includes a first surface which is orthogonal to the X axis and a second surface which is opposite to the first surface, and a distance between the first surface and the second surface (i.e., thickness) is 2 mm. The thermal conductivity of aluminum is 235 W/mK. The thermal expansion coefficient of aluminum is 23×10⁻⁶/K.

Copper (Cu), brass, zinc (Zn), tungsten (W), molybdenum (Mo) and the like can also be used as the metal material of the first temperature adjustment unit. The thermal conductivity (in W/mK) of each metal material is as follows: Copper=403, brass=106, zinc=117, tungsten=177. The thermal expansion coefficient (expressed as 1×10⁻⁶/K) of each metal material is as follows: Copper=16.8, brass=19, zinc=30.2, tungsten=4.3. As a ceramic material, aluminum nitride (AlN), silicon carbide (SiC), and the like can also be used. The thermal conductivity (in W/mK) of each ceramic material is as follows: Aluminum nitride=150, silicon carbide=200. The thermal expansion coefficient (expressed as 1×10⁻⁶/K) of each ceramic material is as follows: Aluminum nitride=4.6, silicon carbide=3.7.

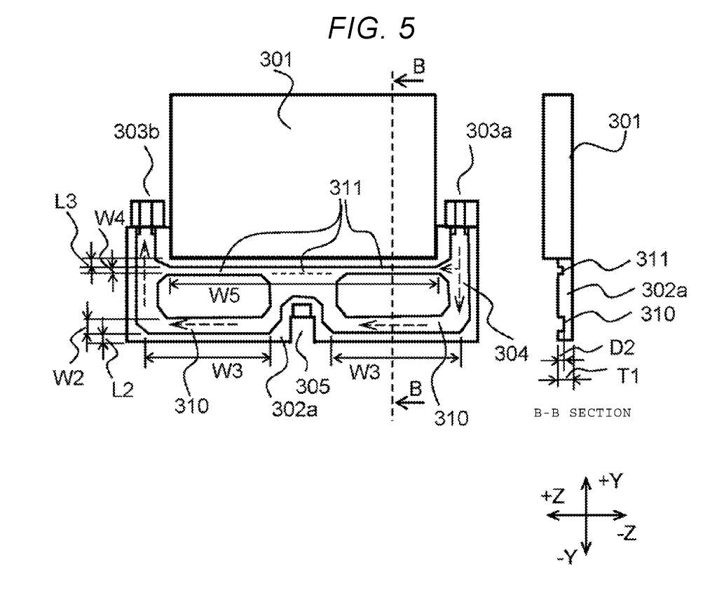

In an example, the second temperature adjustment unit 302 comprises a stacked structure of a first alumina (Al₂O₃) plate 302a and a second alumina (Al₂O₃) plate 302b. The first alumina plate 302a has a length of 64 mm in the Z axis direction, a length of 21 mm in the Y axis direction, and a thickness of 1 mm in the X axis direction. Furthermore, a notch 307, which has a length of 51 mm in the Z axis direction and a length of 5 mm in the Y axis direction, is provided on one end of the first alumina plate 302a in the Y axis direction. A groove having a depth of 0.5 mm is formed on one surface of the first alumina plate 302a in the X axis direction (refer to FIG. 5). The second alumina plate 302b has the same shape as the first alumina plate 302a. The surface of the first alumina plate 302a on which the groove is formed and a surface of the second alumina plate 302b on which a groove is also formed are fixed to each other with an epoxy adhesive agent. At the time of the bonding, the adhesive agent is prevented from flowing into the grooves. A space defined by the grooves of the first alumina plate 302a and the second alumina plate 302b is a flow path 304 through which warm water for temperature adjustment flows.

The first alumina plate 302a and the second alumina plate 302b are stacked onto each other. A distance between a surface of the second alumina plate 302b on which no groove is formed, also referred to as a third surface of the second temperature adjustment unit, and a surface of the first alumina plate 302a on which no groove is formed, also referred to a fourth surface of the second temperature adjustment unit, is 2 mm. The aluminum plate of the first temperature adjustment unit 301 is fitted into the notch 307 of the second temperature adjustment unit 302, which is formed by the first alumina plate 302a and the second alumina plate 302b. An end portion of the first temperature adjustment unit 301 and an end portion of the second temperature adjustment unit 302 are fixed to each other with an epoxy adhesive agent. A notch 305 is provided at the center of an end portion of the second temperature adjustment unit 302 in the Y axis direction. A thermistor 306 for detecting the temperatures of the ink discharging units 200a and 200b is provided in the notch 305. Pipes 303 through which warm water flows into the flow path 304 are provided in the opposite end portions of the second temperature adjustment unit 302 in the Z axis direction.

As illustrated in FIG. 2B, the actuator substrate 203 of the first ink discharging unit 200a is fixed to an upper surface of the second alumina plate 302b, with an epoxy adhesive agent. The actuator substrate 203 of the second ink discharging unit 200b is fixed to a lower surface of the first alumina plate 302a with an epoxy adhesive agent. The piezoelectric actuators 234 which are formed in the actuator substrates 203 of the first and second ink discharging units 200a and 200b are disposed along the flow path 304 of the second temperature adjustment unit. A top portion in the X axis direction of each of the driving circuits 207 provided in the first ink discharging unit 200a is fixed to an upper surface of the first temperature adjustment unit 301, also referred to as a first surface of the first temperature adjustment unit, with an epoxy adhesive agent. A top portion in the X axis direction of each of the driving circuits 207 provided in the second ink discharging unit 200b is fixed to a lower surface of the first temperature adjustment unit 301, also referred to a second surface of the first temperature adjustment unit, with an epoxy adhesive agent. Since the top portions are fixed to the surfaces with thin epoxy adhesive agent layers respectively interposed therebetween, the actuator substrates 203 and the driving circuits 207 are disposed to be close to the temperature adjustment unit 300. The circuit substrates 208 provided in the first and second ink discharging units 200a and 200b are also bonded to the first temperature adjustment unit 301. A method of fixing the driving circuits 207 and the actuator substrates 203 to the aluminum plate with flat springs fixed to the aluminum plate of the first temperature adjustment unit 301 can also be used instead of the fixing method using an adhesive agent. Specifically, “be in contact with each other” conceptually indicates being close to each other within a distance therebetween including the thickness of the adhesive agent layer being so short that heat can be sufficiently transmitted from the second temperature adjustment unit 302 to the actuator substrate 203. The expression “be in contact with each other” indicates being close to each other within a distance therebetween including the thickness of the adhesive agent layer being so short that heat can be sufficiently transmitted from the driving circuit 207 to the first temperature adjustment unit 301. Furthermore, the expression “be in contact with each other” indicates being close to each other such that heat can be sufficiently transmitted therebetween even when another fixing method besides adhesive fixing, such as a fixing method using a spring is used.

The second temperature adjustment unit 302 is a stacked structure of the alumina plates 302a and 302b. The second temperature adjustment unit 302 also functions as a supporting body which supports the two ink discharging units 200a and 200b. The thermal expansion coefficient of alumina is 7.7×10⁻⁶/K and the thermal conductivity of alumina is 2 W/mK. The thermal expansion coefficient of the PZT of the actuator substrate 203 is 8×10⁻⁶/K and the thermal conductivity of the PZT of the actuator substrate 203 is 2 W/mK. The alumina is selected such that a difference between the thermal expansion coefficient of the second temperature adjustment unit 302 and the thermal expansion coefficient of the actuator substrate 203 is small. Instead of alumina, yttria (Y₂O₃), cermet (TiC·TiN), steatite (MgO·SiO₂) can also be used. The thermal expansion coefficient (expressed as 1×10⁻⁶/K) of each material is as follows: Yttria=7.2, cermet=7.4, steatite=7.7. If a difference between the thermal expansion coefficient of the second temperature adjustment unit 302 and the thermal expansion coefficient of the actuator substrate 203 is large, the temperature rises and the actuator substrate 203 may be warped. If the actuator substrate 203 is warped, the actuator substrate 203 is deformed in the X axis direction. Due to this deformation, there is a positional deviation in the X axis direction of an ink droplet 211 discharged from a nozzle 220 in the center portion in the Z axis direction and an ink droplet 211 discharged from a nozzle 220 in an end portion in the Z axis direction. To suppress the positional deviation of the ink droplets 211 on the recording medium S, the difference between the thermal expansion coefficient of the second temperature adjustment unit 302 and the thermal expansion coefficient of the actuator substrate 203 is selected to be small. It is typically preferable that a difference between the thermal expansion coefficient of the second temperature adjustment unit 302 and the thermal expansion coefficient of the actuator substrate 203 is within 10% of the thermal expansion coefficient of the second temperature adjustment unit 302.

FIG. 5 illustrates the shape of the groove formed in the first alumina plate 302a. As described above, the thickness T1 of the first alumina plate 302a is 1 mm and the depth D2 of the groove of the first alumina plate 302a is 0.5 mm. The flow path 304 has a shape which is obtained by combining the grooves formed in the first alumina plate 302a and the second alumina plate 302b. End portions of first flow path grooves 310a and 310b and a second flow path groove 311 are connected to a pipe 303a and a pipe 303b. The first flow path groove 310a is connected to the pipe 303a and is formed to have a flow path width W2 of 4 mm and a length W3 of 23 mm at a position which is separated from an end in the Y axis direction of the first alumina plate 302a by a distance L2 of 1 mm. Similarly to the first flow path groove 310a, the first flow path groove 310b is connected to the pipe 303b and is formed to have a flow path width W2 of 4 mm and a length W3 of 23 mm at a position which is separated from an end in the Y axis direction of the first alumina plate 302a by a distance L2 of 1 mm. Each of the first flow path grooves 310a and 310b is disposed to be parallel with the Z axis and has the length W3. In addition, the first flow path grooves 310a and 310b communicate with each other while bypassing the above-described notch 305. The second flow path groove 311 is formed to have a flow path width W4 of 1.5 mm and a length W5 of 50 mm at a position which is separated from the other end, at a boundary between first temperature adjustment unit 301 and second temperature adjustment unit 302, in the Y axis direction of the first alumina plate 302a by a distance L3 of 1.5 mm. A groove having the same shape as the groove in the first alumina plate 302a is formed in the second alumina plate 302b. When the first and second alumina plates 302a and 302b are bonded to each other, the flow path 304 is formed in the second temperature adjustment unit 302. The pipes 303a and 303b are bonded to the second temperature adjustment unit 302 in which the flow path 304 is formed.

An operation of the ink jet head 1 configured as described above will be described.

As described above, the ink jet head 1 includes the ink discharging units 200a and 200b on the opposite surfaces in the X axis direction of the temperature adjustment unit 300. In each of the actuator substrates 203 of the ink discharging units 200a and 200b, the plurality of piezoelectric actuators 234 are linearly disposed in the Z axis direction. The pressure chamber 235 is formed between two adjacent piezoelectric actuators 234. Due to shearing deformation of the piezoelectric actuators 234, the volume of the pressure chamber 235 increases or decreases. Ink is supplied into the pressure chambers 235 by the volumes of the pressure chambers 235 being increased and the ink droplets 211 are discharged via the nozzles 220 by the volumes of the pressure chambers 235 being returned. After the ink droplets 211 are discharged, the volumes of the pressure chambers 235 are decreased so that residual vibration of ink in the pressure chambers 235 is suppressed.

When one ink droplet 211 is discharged, two adjacent piezoelectric actuators 234 are subject to shearing deformation. If PZT material of the piezoelectric actuator 234 is repeatedly subject to shearing deformation, the PZT material generates heat. The number of times that the plurality of piezoelectric actuators 234 are deformed depends on an image signal that is input to the ink jet head 1. When a text character is printed, the number of times that the piezoelectric actuators 234 are operated is relatively small. Since the number of times that the plurality of piezoelectric actuators 234 are operated is small, the average quantity of heat generated by the piezoelectric actuators 234 is also relatively small. When an image is obtained by completely filling a certain area with ink droplets, the number of times that the piezoelectric actuators 234 are operated is larger. When the number of times that the piezoelectric actuators 234 are operated is increased, the average amount of heat generated by the piezoelectric actuators 234 is also increased. When the quantity of heat is increased, the temperature of ink rises. When the temperature of ink rises, the viscosity of ink decreases. When the viscosity of ink decreases, the amount of discharged ink is increased even if there is no change in the degree of shearing deformation of the piezoelectric actuators 234. In addition, when the temperature in the vicinity of the ink jet head 1 is lower, the viscosity of ink increases and the amount of discharged ink is decreased.

A change in temperature of ink may be suppressed by warm water having a constant temperature flowing into the flow path 304 of the second temperature adjustment unit 302. The warm water is supplied from the warm water tank 120 to the flow path 304. In the first embodiment, the temperature of the warm water flowing into the flow path 304 is set to 45° C. to maintain the viscosity of ink to be constant. The selected temperature of the warm water depends on characteristics of ink. The warm water flows through the first flow path grooves 310a and 310b and the second flow path groove 311. As illustrated in FIG. 2B, the flow path 304 which is formed by the first flow path grooves 310a and 310b is formed to be separated from the piezoelectric actuators 234 of the ink discharging units 200a and 200b by approximately 1 mm in the X axis direction. Therefore, even though the thermal conductivity of the alumina plates 302a, 302b, and PZT is 2 W/mK, which is relatively small, it is possible to efficiently suppress heat generated by the piezoelectric actuators 234. Instead of the warm water, oil with a low viscosity flowing into the flow path 304 after being heated to a predetermined temperature may be used in some examples.

The top portion of each driving circuit 207 is disposed to be close to one surface of the first temperature adjustment unit 301 and is disposed in the vicinity of the boundary between the first temperature adjustment unit 301 and the second temperature adjustment unit 302. Furthermore, the two driving circuits 207 of each of the first and second ink discharging units 200a and 200b are disposed to be close to the first temperature adjustment unit 301. As described above, to discharge one ink droplet from one pressure chamber 235, four FETs are operated. If the number of times ink droplets are discharged per unit time is increased, each driving circuit 207 generates heat in the Z axis direction along the length of each driving circuit 207. The driving circuits 207 are disposed to be approximately parallel to the boundary between the first temperature adjustment unit 301 and the second temperature adjustment unit 302. The heat generated by the driving circuits 207 can be diffused in a +Y direction through aluminum having a high thermal conductivity. Transmission of the heat through aluminum in the −Y direction, to the ink discharging units 200a and 200b is reduced due to the second temperature adjustment unit 302, which is maintained at a constant temperature with warm water.

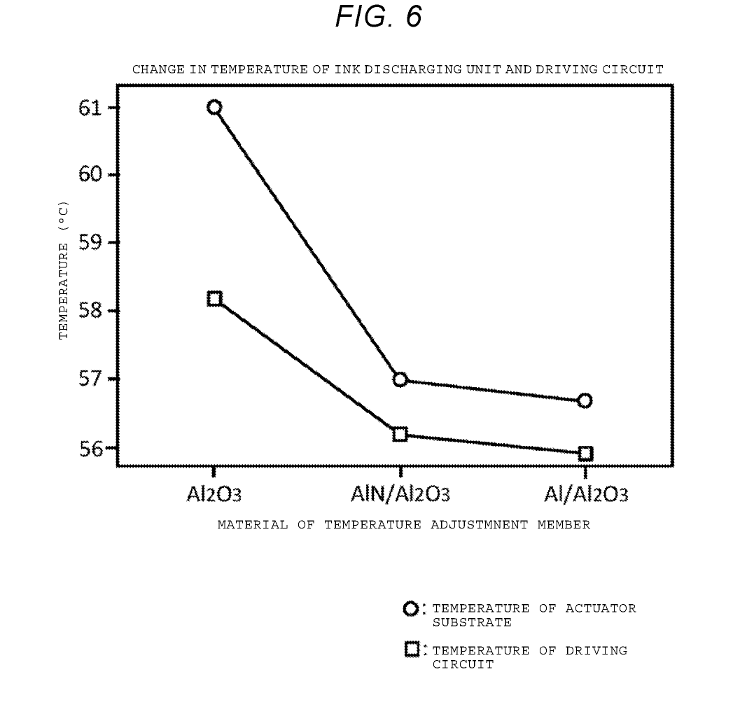

FIG. 6 illustrates the dependency of the temperature of the actuator substrate 203 and the temperature of the driving circuit 207 on the temperature adjustment unit 300. The graph shows the result of a temperature calculation pertaining to cases where there is a change in material of the first temperature adjustment unit 301 and the second temperature adjustment unit 302. The vertical axis represents temperature and the horizontal axis represents the material of a combination of the first temperature adjustment unit 301 and the second temperature adjustment unit 302. The circle marks represent the temperature of the actuator substrate 203 and the square marks represent the temperature of the driving circuit 207. The circle mark and the square mark on the left hand end of the X-axis represent a comparative example in which the first temperature adjustment unit 301 and the second temperature adjustment unit 302 are both formed of alumina (Al₂O₃). The first temperature adjustment unit 301 and the second temperature adjustment unit 302, which are both formed of alumina, and integrated with each other in a comparative example, as depicted in FIG. 11. The external appearance of this comparative example is substantially the same as that of the temperature adjustment unit 300 in the first embodiment despite internal differences.

The circle mark and the square mark at the center portion of the X-axis represent another comparative example in which the first temperature adjustment unit 301 is formed of aluminum nitride (AlN) and the second temperature adjustment unit 302 is formed of alumina (Al₂O₃). In this comparative example, the shape of the first temperature adjustment unit 301, which here is formed of aluminum nitride, is the same as the shape of the above-described first temperature adjustment unit 301 according to the first embodiment, which is formed of aluminum. In this middle comparative example, the shape of the second temperature adjustment unit 302, which is formed of alumina (Al₂O₃), is the same as the shape of the above-described second temperature adjustment unit 302, and also formed of alumina as in the first embodiment. The circle mark and the square mark on the right-hand end of the X-axis represent the first embodiment, as described above, in which the first temperature adjustment unit 301 is formed of aluminum (Al) and the second temperature adjustment unit 302 is formed of alumina (Al₂O₃). As can be understood from FIG. 6, a combination of a first temperature adjustment unit 301, which has a high thermal conductivity, and a second temperature adjustment unit 302, which has a low thermal conductivity, and for which the thermal expansion coefficient is only slightly different from that of PZT, results in a decrease in temperature of the actuator substrate 203 and temperature of the driving circuit 207 in comparison with the two comparative examples.

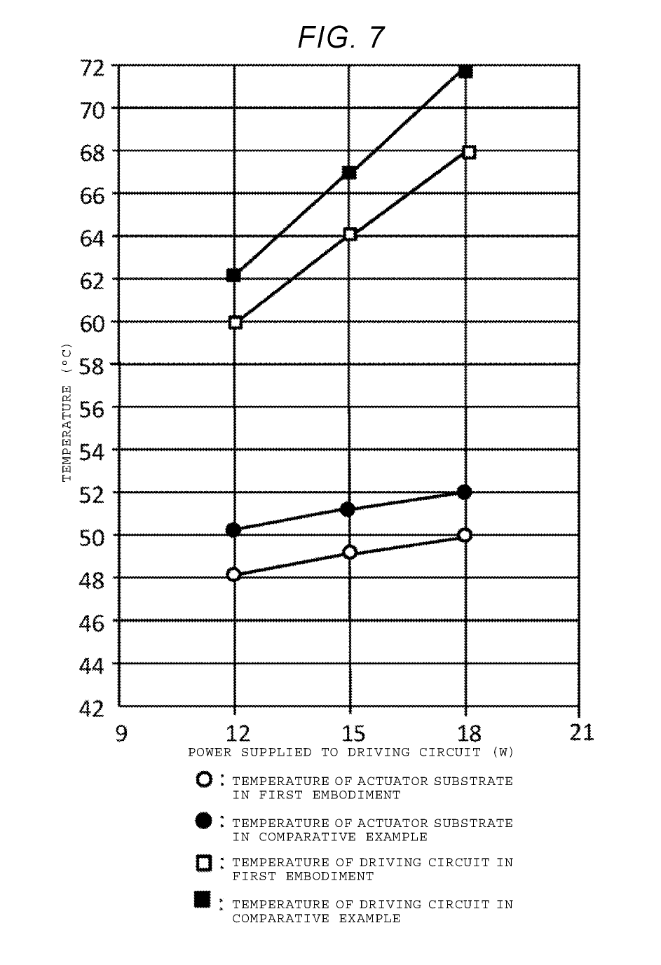

FIG. 7 illustrates a relationship between power supplied to the driving circuits 207 of the ink discharging units 200a and 200b and the temperatures of the actuator substrate 203 and the driving circuit 207. The graph shows a calculated result in which the temperature of the actuator substrate 203 and the temperature of the driving circuit 207 are obtained with respect to the average of power supplied to the driving circuit 207. Here, the first temperature adjustment unit 301 is formed of aluminum (Al) and the second temperature adjustment unit 302 is formed of alumina (Al₂O₃). The horizontal axis represents power (in watts (W)) supplied to the driving circuit 207 and the vertical axis represents temperature (° C.). The unfilled circles represent the temperature of the actuator substrate 203 in the first embodiment. The filled (black) circles represent the temperature of the actuator substrate which is provided on the temperature adjustment unit 300 in a comparative example. The unfilled squares represent the temperature of the driving circuit 207 in the first embodiment. The filled (black) squares represent the temperature of the driving circuit 207 which is provided on the temperature adjustment unit 300 in the comparative example. The results for temperature adjustment unit 300 are for the comparative example as depicted in FIG. 7 having an integrated alumina structure (see in FIG. 11). The temperature of the actuator substrate 203 in the first embodiment is lower than the temperature of the actuator substrate of the comparative example. The temperature of the driving circuit 207 in the first embodiment also can be lowered in comparison with the temperature of the driving circuit of the comparative example. Therefore, as the supplied power increases, a difference between the temperatures of the driving circuits 207 increases. The difference in temperature may increase due to a combination of the first temperature adjustment unit 301 and the second temperature adjustment unit 302. Furthermore, a smaller supplied power corresponds to smaller amount of discharged ink such as for printing a text character. A larger supplied power corresponds to larger amount of discharged ink for printing an image region that is completely filled with ink.

In the first embodiment, the first temperature adjustment unit 301 has a first thermal conductivity and is provided to be close to the driving circuits 207. The second temperature adjustment unit includes an internal flow path through which liquid flows, has a second thermal conductivity that is lower than the first thermal conductivity, and is provided to be close to the actuator substrate. Thus, it is possible to efficiently control the temperature of the ink discharging unit. In addition, since a difference between the thermal expansion coefficient of the actuator substrate 203 and the thermal expansion coefficient of the second temperature adjustment unit 302 is set to be smaller than a difference between the thermal expansion coefficient of the actuator substrate 203 and the thermal expansion coefficient of the first temperature adjustment unit 301, even if the temperature of the actuator substrate 203 rises due to the ambient temperature or a driving operation, warping of the actuator substrate 203 can be suppressed. Therefore, it is possible to perform printing with high ink droplet landing positional accuracy.

The first temperature adjustment unit 301 and the second temperature adjustment unit 302 are thin plates having a same thickness in the above examples. Therefore, a distance between the ink discharging units 200a and 200b in the X axis direction can be shortened. Thus, the ink jet head 1 which includes the ink discharging units 200a and 200b on the opposite surfaces of the temperature adjustment unit 300 can be miniaturized.

As described above, the ink jet printer 100 includes an ink jet head including a substrate that is provided with an actuator, which is operated by a driving signal and applies a discharge pressure to ink in a pressure chamber communicating with a nozzle, a driving circuit that generates the driving signal, a first temperature adjustment unit that has a first thermal conductivity and is provided to be in contact with the driving circuit, and a second temperature adjustment unit that includes an internal flow path through which liquid flows, has a second thermal conductivity lower than the first thermal conductivity, and is provided to be in contact with the substrate, a liquid storage unit that stores liquid to be supplied to the flow path, a controller that controls the temperature of the liquid, a supply unit that supplies the liquid from the liquid storage unit to the controller, and a medium transportation unit that transports a recording medium on which the ink jet head performs recording.

A temperature control method for an ink jet head according to the first embodiment will be described. The ink jet head includes a substrate that is provided with an actuator, which is operated by a driving signal and applies a discharge pressure to ink in a pressure chamber communicating with a nozzle and a driving circuit that generates the driving signal. The method includes bringing the driving circuit in contact with a first temperature adjustment unit that has a first thermal conductivity, bringing the substrate in contact with a second temperature adjustment unit that includes an internal flow path through which liquid flows and that has a second thermal conductivity lower than the first thermal conductivity, and supplying liquid having a predetermined temperature to the flow path.

### Second Embodiment

In the ink jet head 1 in a second embodiment, the configuration of the temperature adjustment unit 300 is different from that of the temperature adjustment unit 300 in the first embodiment. Except for this difference, the configuration of the inkjet head 1 is substantially the same as that of the first embodiment.

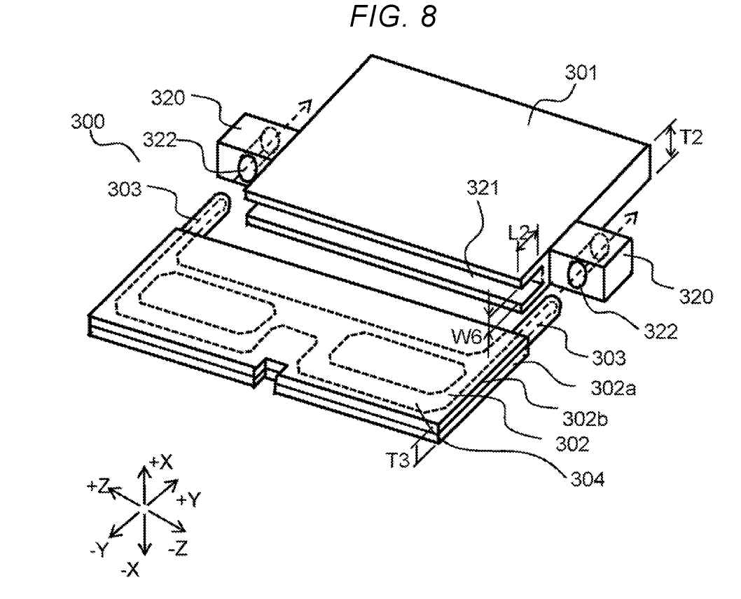

Description will be made with reference to FIG. 8. The first temperature adjustment unit 301 is an aluminum plate having a thickness T2 of 4 mm. An opening 321 is formed at one end of the first temperature adjustment unit 301 in the Y axis direction. The opening 321 is formed to have a width W6 of 2 mm in the X axis direction and a length L2 of 5 mm in the Y axis direction. The first temperature adjustment unit 301 includes supporting portions 320 on the opposite sides thereof in the Z axis direction. The supporting portions 320 include pipe openings 322 through which the pipes 303 of the second temperature adjustment unit 302 pass through. The pipes 303 pass through the pipe openings 322 and are fixed to the supporting portions 320. The supporting portions 320 are used to fix the ink jet head 1 to the ink jet printer 100.

The second temperature adjustment unit 302 has a thickness T3 of 2 mm and is formed of alumina. As with the first embodiment, the first alumina plate 302a having a thickness of 1 mm and the second alumina plate 302b having a thickness of 1 mm are stacked onto each other. As with the first embodiment, the flow path 304 through which warm water flows is provided in the second temperature adjustment unit 302.

The second temperature adjustment unit 302 which is obtained by stacking the alumina plates 302a and 302b is fitted into the opening 321 of the first temperature adjustment unit 301, which is formed of aluminum, and is fixed with an adhesive agent. The contact area between the first temperature adjustment unit 301 and the second temperature adjustment unit 302 is increased in comparison with the temperature adjustment unit 300 in the first embodiment. With the contact area being increased, it is possible to more efficiently transfer heat that is generated by the actuator substrate 203 to the first temperature adjustment unit 301 that is formed of aluminum and has a high thermal conductivity and a large thermal capacity.

### Third Embodiment

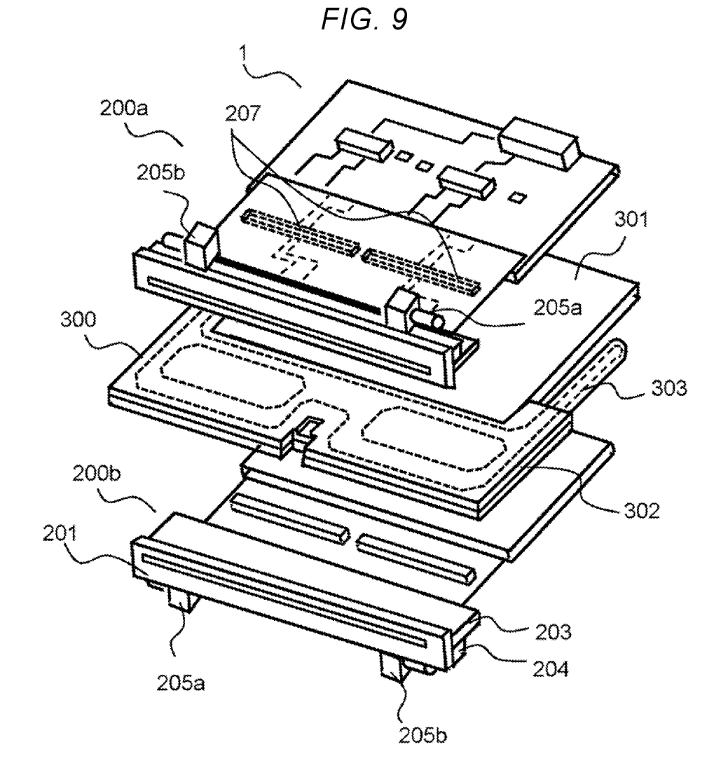

The configuration of the ink jet head 1 in a third embodiment will be described with reference to FIG. 9. The configuration of the ink supply port 205 of each of the ink discharging units 200a and 200b is different from that of the ink jet head 1 in the first embodiment. Except for the configuration of the ink supply port 205, the ink jet head 1 in the third embodiment is substantially the same as the ink jet head 1 in the first embodiment.

In the third embodiment, an ink supply port 205a and an ink supply port 205b are provided. Each of the ink supply ports 205a and 205b includes a cylindrical tube which bends at a right angle. Each cylindrical tube communicates with common ink chamber 241. Ink is supplied from the ink supply port 205a and a portion of the ink is discharged via the nozzles 220. The remaining ink is discharged via the ink supply port 205b. The ink discharged via the ink supply port 205b is supplied to the ink supply port 205a again via an ink circulating device (not specifically depicted). Ink circulates through the common ink chamber 241. Even when where air bubbles are generated in the ink discharging units 200a and 200b, it is easy to remove the air bubbles since the ink circulates.

### Fourth Embodiment

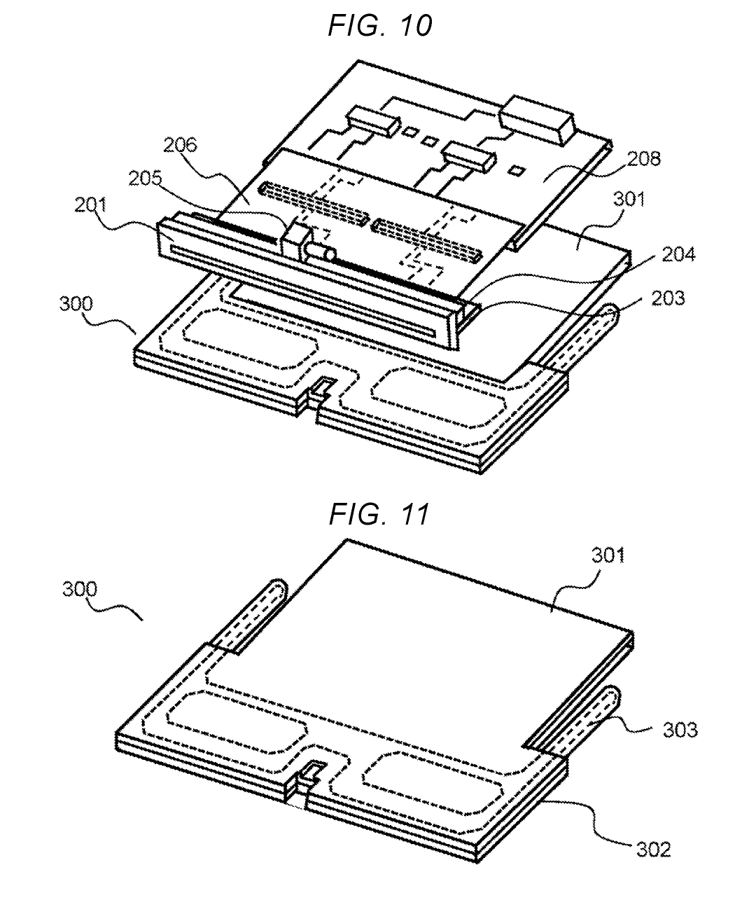

The ink jet head 1 in a fourth embodiment will be described with reference to FIG. 10. In the first embodiment, the ink discharging units 200a and 200b are provided on the upper and lower surfaces of the temperature adjustment unit 300. In the ink jet head 1 in the fourth embodiment, only a single ink discharging unit is provided on a surface of the temperature adjustment unit 300. Except that the ink discharging unit is provided on only one surface of the temperature adjustment unit 300, the fourth embodiment is substantially the same as the first embodiment. Since the ink discharging unit is provided on only one surface of the temperature adjustment unit 300, heat dissipation through the first temperature adjustment unit 301 can be preferably performed. In addition, it may be easier to stably maintain the temperature of ink passing through the second temperature adjustment unit 302.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink jet head, comprising:
a first pressure chamber connected to a first nozzle;
a first actuator substrate including a first actuator that is configured to cause a pressure change in the first pressure chamber to discharge ink through the first nozzle in response to a first driving signal;
a first driving circuit configured to generate the first driving signal;
a first temperature adjustment unit in contact with the first driving circuit and having a first thermal conductivity; and
a second temperature adjustment unit having an internal flow path through which a liquid can flow and a second thermal conductivity that is lower than the first thermal conductivity, the second temperature adjustment unit being in contact with the first actuator substrate.

2. The ink jet head according to claim 1, wherein
the first temperature adjustment unit comprises a metal plate, and
the second temperature adjustment unit comprises a stack of a first ceramic plate and a second ceramic plate.

3. The ink jet head according to claim 2, wherein a difference between a thermal expansion coefficient of the first actuator substrate and a second thermal expansion coefficient of the second temperature adjustment unit is within 10% of the thermal expansion coefficient of the first actuator substrate.

4. The ink jet head according to claim 1, further comprising:
a second pressure chamber connected to a second nozzle;
a second actuator substrate including a second actuator that is configured to cause a pressure change in the second pressure chamber in response to a second driving signal; and
a second driving circuit configured to generate the second driving signal, wherein
the first temperature adjustment unit is between the first driving circuit and the second driving circuit, and
the second temperature adjustment unit is between the first actuator substrate and the second actuator substrate.

5. The ink jet head according to claim 4, wherein
the first temperature adjustment unit has a first surface facing the first driving circuit and a second surface facing the second driving circuit,
the second temperature adjustment unit has a third surface facing the first actuator substrate and a fourth surface facing the second actuator substrate, and
a distance between the first surface and the second surface is greater than a distance between the third surface and the fourth surface.

6. The ink jet head according to claim 1, further comprising:
an opening at one end of the first temperature adjusting unit, within which the second temperature adjusting unit is disposed.

7. An ink jet printer, comprising:
a sheet feeder configured to feed a sheet on which an image can be recorded;
an inkjet head configured to dispense ink onto the sheet and comprising:
a first pressure chamber connected to a first nozzle;
a first actuator substrate including a first actuator that is configured to cause a pressure change in the first pressure chamber in response to a first driving signal;
a first driving circuit configured to generate the first driving signal;
a first temperature adjustment unit in contact with the first driving circuit and having a first thermal conductivity; and
a second temperature adjustment unit having an internal flow path through which a liquid can flow and a second thermal conductivity that is lower than the first thermal conductivity, the second temperature adjustment unit being in contact with the first actuator substrate;
an ink storage container connected to the first pressure chamber and from which ink is supplied to the first pressure chamber; and
a first ink supply port through which the ink is supplied to the first pressure chamber from the ink storage container.

8. The ink jet printer according to claim 7, wherein
the first temperature adjustment unit comprises a metal plate, and
the second temperature adjustment unit comprises a stack of a first ceramic plate and a second ceramic plate.

9. The ink jet printer according to claim 8, wherein a difference between a thermal expansion coefficient of the first actuator substrate and a thermal expansion coefficient of the second temperature adjustment unit is within 10% of the thermal expansion coefficient of the first actuator substrate.

10. The ink jet printer according to claim 8, wherein
the first ceramic plate has grooves facing the second ceramic plate, and
the second ceramic plate has grooves connecting to the grooves of the first ceramic plate.

11. The ink jet printer according to claim 7, wherein
the ink jet head further comprises:
a second pressure chamber connected to a second nozzle;
a second actuator substrate including a second actuator that is configured to cause a pressure change in the second pressure chamber in response to a second driving signal; and
a second driving circuit configured to generate the second driving signal,
the first temperature adjustment unit is between the first driving circuit and the second driving circuit, and
the second temperature adjustment unit is between the first actuator substrate and the second actuator substrate.

12. The ink jet printer according to claim 11, wherein the first temperature adjustment unit has a first surface facing the first driving circuit and a second surface facing the second driving circuit,
the second temperature adjustment unit includes a third surface facing the first actuator substrate and a fourth surface facing the second actuator substrate, and
a distance between the first surface and the second surface is greater than a distance between the third surface and the fourth surface.

13. The ink jet printer according to claim 7, further comprising:
an opening formed at one end of the first temperature adjusting unit, wherein the second temperature adjusting unit is disposed within the opening.

14. The ink jet printer according to claim 7, further comprising:
a second ink supply port connected to the first pressure chamber, the second ink supply port receiving ink that has been supplied to the first pressure chamber through the first ink supply port, wherein
the first ink supply port and the second ink supply port are connected such that ink can circulate therebetween.

15. An ink jet head, comprising:
a first pressure chamber connected to a first nozzle;
a first actuator configured to cause a pressure change in the first pressure chamber in response to a first driving signal;
a first driving circuit configured to generate the first driving signal;
a first temperature adjustment unit in contact with the first driving circuit and having a first thermal conductivity;
and a second temperature adjustment unit having an internal flow path through which a liquid can flow and a second thermal conductivity that is lower than the first thermal conductivity, the second temperature adjustment unit being in contact with the first actuator substrate.

16. The ink jet head according to claim 15, wherein
the first temperature adjustment unit comprises a metal plate, and
the second temperature adjustment unit comprises a stack of a first ceramic plate and a second ceramic plate.

17. The ink jet head according to claim 16, wherein
the first ceramic plate has grooves facing the second ceramic plate, and
the second ceramic plate has grooves connecting to the grooves of the first ceramic plate.

18. The ink jet head according to claim 15, further comprising:
a second pressure chamber connected to a second nozzle;
a second actuator configured to cause the pressure change in the second pressure chamber in response to a second driving signal; and
a second driving circuit configured to generate the second driving signal, wherein
the first temperature adjustment unit is between the first driving circuit and the second driving circuit, and
the second temperature adjustment unit is between the first actuator and the second actuator.

19. The ink jet head according to claim 15, further comprising:
an opening formed at one end of the first temperature adjusting unit, wherein the second temperature adjusting unit is disposed within the opening.

20. The ink jet head according to claim 18, wherein the first and second actuator each comprise a stack of a first piezoelectric material and a second piezoelectric material that are polarized in an opposite direction.
